(19) United States
(12) Patent Application Publication
(10) Pub. No.: US 2025/0072588 A1
(43) Pub. Date: Mar. 6, 2025

(54) PORTABLE MOBILE PHONE FIXED MOUNT

(71) Applicant: Jianping Zhu, Huangshan, Anhui (CN)

(72) Inventor: Jianping Zhu, Huangshan, Anhui (CN)

(21) Appl. No.: 18/273,648

(22) PCT Filed: Jun. 27, 2023
(86) PCT No.: PCT/CN2023/102625

§ 371 Date: Jul. 21, 2023

(51) Int. Cl. A45F 5/00; H04M 1/04

(52) U.S. Cl. CPC A45F 5/00; H04M 1/04; A45F 5/1516

(57) ABSTRACT

The invention discloses a portable mobile phone fixed mount, comprising a strap, a mobile phone clamp component and article placing bags; the strap consists of a chest and waist belt and shoulder belts wherein chest and waist belt is provided with a hasp; the mobile phone clamp component comprises a mounting plate, a mount adjusting mechanism and a mobile phone clamp; a plurality of article placing bags are fixed on chest and waist belt; the invention is worth promoting because it realizes portable design to the cellphone supporting tool, set up as an organic whole with the strap, alleviating burden of long-term lifting cellphone or selfie stick on the way, and improving enjoyment of hiking. The mobile phone clamp component is located at the joint of chest and waist belt and strap, one side of body, facilitating customers uses, having advantages of storing more articles, rich functions and good expansibility.

### 1. TECHNICAL FIELD

The invention relates to the technical field of electronic device accessories, in particular to a portable mobile phone fixed mount.

### 2. BACKGROUND ART

As a convenient communication tool, mobile phones is widely used with the improvement of people's living standard. With the coming of internet era, the information that people need to receive and handle are increased dramatically, and mobile phone, a mobile terminal within reach, has gradually become a dispensable part of people's living, production and recreation. People tend to take up other activities when using the phone, and many mobile phone clamping tools have appeared on the market to free hands and make people better engage in other activities. Most of the products are suitable for relative static places such as indoor and in-vehicle atmosphere and are not suitable for outdoor travel.

### 3. SUMMARY OF THE INVENTION

In order to solve above problems, the technical scheme provided by the invention is a portable mobile phone fixed mount.

A portable mobile phone fixed mount comprises a strap, a mobile phone clamp component and article placing bags;
said strap consists of a chest and waist belt and shoulder belts wherein on the chest and waist belt is provided with a hasp;
the mobile phone clamp component comprises a mounting plate, a mount adjusting mechanism and a mobile phone clamp; said mounting plate is arranged on the front side of the strap and is positioned at the joint of the chest and waist belt and the shoulder belts; the mount adjusting mechanism is rotatably connected with the mounting plate; the mount adjusting mechanism can be lifted and folded and is accommodated on the mounting plate; the mobile phone clamp is arranged on one side of mount adjusting mechanism away from the mounting plate;
a plurality of article placing bags are fixed on chest and waist belt;

As an improvement, the chest and waist belt comprises elastic bands and adjustable fixing bands, the chest and waist belt is connected with the shoulder belts through movable lantern rings, and can be adjusted and worn by people with different body types.

As an improvement, two parallel placing grooves are formed on the mounting plate along the longitudinal direction.

As an improvement, the mount adjusting mechanism comprises a rotating seat, a first rotating arm, a connecting shaft and a second rotating arm; the rotating seat is arranged between the two placing grooves; one end of the first rotating arm is rotatably connected with the rotating seat; the connecting shaft is rotatably arranged at one end of the first rotating arm far away from the rotating seat; the lower end of the second rotating arm is rotatably connected with the connecting shaft.

As an improvement, a sunshade connecting port is arranged at the top end of the second rotating arm.

As the improvement, groove body is equipped on the first rotating arm, and in the groove body is equipped with a rotatably connected auxiliary support bar, which is retractable, and support stability of first rotating arm can be strengthened when the bottom is pressed against the mounting plate.

As an improvement, there are three article placing bags, respectively positioned at the connecting parts of the spare chest and waist belt and the shoulder belts.

As an improvement, the strap is made of cow leather, artificial leather or elastic band.

Compared with the prior art, the invention has following advantages: the invention is worth promoting because it realizes portable design to the cellphone supporting tool, set up as an organic whole with the strap, alleviating burden of long-term lifting cellphone or selfie stick on the way, and improving enjoyment of hiking. The mobile phone clamp component is located at the joint of chest and waist belt and strap, one side of body, facilitating customers uses, having advantages of storing more articles, rich functions and good expansibility.

### 4. BRIEF DESCRIPTION OF ACCOMPANY DRAWINGS

FIG. 1 is the first structural diagram of a portable mobile phone fixed mount provided by the invention.

FIG. 2 is the second structural diagram of a portable mobile phone fixed mount provided by the invention.

FIG. 3 is the main view of a portable mobile phone fixed mount provided by the invention.

FIG. 4 is the side view of a portable mobile phone fixed mount provided by the invention.

As shown in the accompanying drawings: 1 strap, 2 mounting plate, 3 mobile phone clamp, 4 article placing bag, 5 placing groove, 6 rotating seat, 7 first rotating arm, 8 connecting shaft, 9 second rotating arm, 10 sunshade connecting port, 11 auxiliary support bar.

### 5. SPECIFIC EMBODIMENT OF THE INVENTION

The invention is further described in detail hereinafter with reference to the drawings.

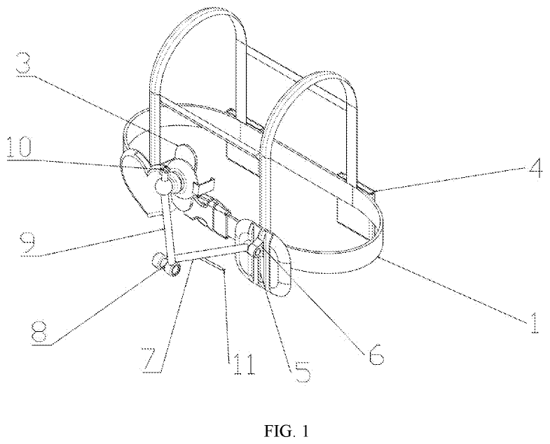

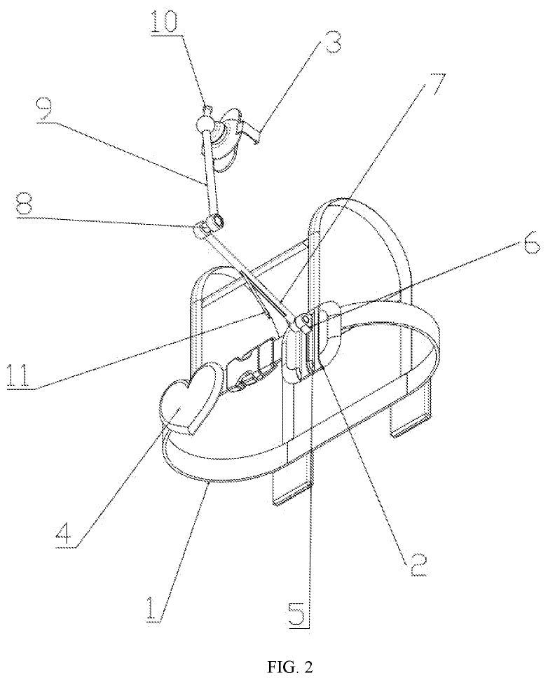

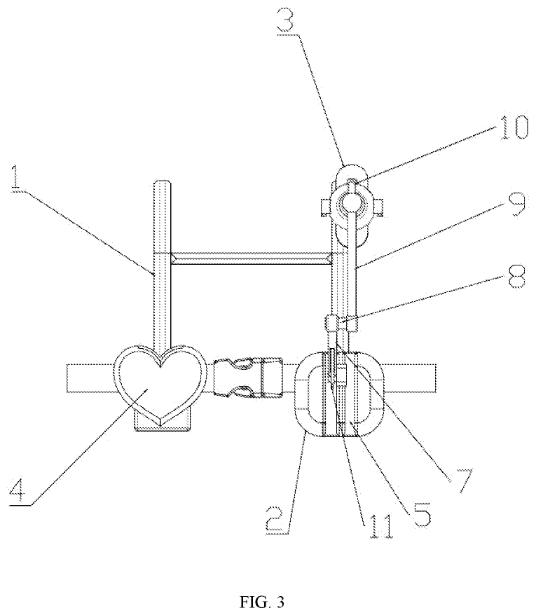

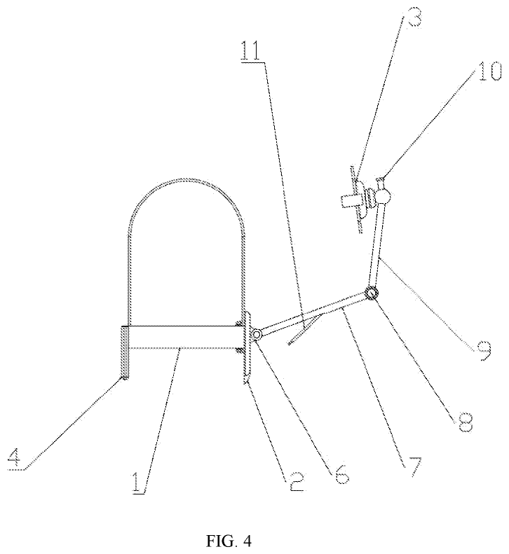

With reference from FIG. 1 to FIG. 4, a portable mobile phone fixed mount comprises a strap 1, a mobile phone clamp component and article placing bags 4;
said strap 1 consists of a chest and waist belt and shoulder belts wherein on chest and waist belt is provided with a hasp;
said mobile phone clamp component comprises a mounting plate 2, a mount adjusting mechanism and a mobile phone clamp 3; said mounting plate 2 is arranged on the front side of the strap 1 and is positioned at the joint of the chest and waist belt and the shoulder belts; the mount adjusting mechanism is rotatably connected with the mounting plate 2; the mount adjusting mechanism can be lifted and folded and is accommodated on the mounting plate 2; the mobile phone clamp 3 is arranged on one side of mount adjusting mechanism away from the mounting plate 2;
a plurality of article placing bags 4 are fixed on chest and waist belt.

Said chest and waist belt comprises elastic bands and adjustable fixing bands, the chest and waist belt is connected with the shoulder belts through movable lantern rings, and can be adjusted and worn by people with different body types.

Two parallel placing grooves 5 are formed on the mounting plate 2 along the longitudinal direction.

The mount adjusting mechanism comprises a rotating seat 6, a first rotating arm 7, a connecting shaft 8 and a second rotating arm 9; the rotating seat 6 is arranged between the two placing grooves 5; one end of the first rotating arm 7 is rotatably connected with the rotating seat 6; the connecting shaft 8 is rotatably arranged at one end of the first rotating arm 7 far away from the rotating seat 6; the lower end of the second rotating arm 9 is rotatably connected with the connecting shaft 8.

A sunshade connecting port 10 is arranged at the top end of the second rotating arm 9 to mount the sunshade.

Groove body is equipped on the first rotating arm 7, and in the groove body is equipped with a rotatably connected auxiliary support bar 11, which is retractable, and support stability of first rotating arm 7 can be strengthened when the bottom is pressed against the mounting plate.

There are three article placing bags 4, respectively positioned at the connecting parts of the spare chest and waist belt and the shoulder belts. The power bank can be placed in the article placing bags 4 and is connected with the mobile phone clamp 3 through the USB connecting wire, two ends of the USB connecting wire can be respectively connected with the mobile phone placed on the mobile phone clamp 3 and the power bank placed in the article placing bag 4, a wire slot is formed in the chest and waist belt, the interior of the mobile phone mount is hollow, the charging wire runs in the wire slot and each rod of the mobile phone mount, two ends of the USB wire extend to the article placing bags 4 and the mobile phone clamp 3 and is used for improving the endurance of the mobile phone.

The strap 1 is made of cow leather, artificial leather or elastic belts.

The invention discloses a theory of operation: when a user uses the device, the user adjusts and wears the strap 1 on the body, and the mounting plate 2 is placed on the chest and abdomen, so that actions such as walking and the like are not influenced; the mounting plate 2 is provided with a mount adjusting mechanism which is rotatably connected with the mounting plate 2 and is used for supporting the mobile phone clamp 3, and multi-angle and multi-height adjustment can be carried out according to actual needs, making the shooting activity more convenient; meanwhile, the weight is distributed on the strap 1 so as to reduce the burden of lifting the mobile phone or the selfie stick during long-distance hiking; when the mobile phone clamp 3 is used, the mount adjusting mechanism can be rotated and folded, so that the first rotating arm 7 and the second rotating arm 9 are both accommodated in the groove body; the top end of the second rotating arm 9 is provided with a sunshade connecting port 10, so that sunshades with different specifications can be installed and the mobile phone can be shaded, reducing the influence of light on a user; the article placing bags 4 arranged on the two sides of the waist can be used for placing devices such as power bank, charging wire and memory card, improving the versatility of the strap 1.

It should be noted that: the mobile phone clamp component, the mounting plate 2 and the article placing bags 4 are provided with three fixing points, which is convenient to disassemble and assemble and is favorable for fine adjustment of customers

The above description of the invention and the embodiments thereof is not restricted, and the accompanying drawings are only one of the embodiments of the invention, and the actual structure is not limited thereto. In conclusion, the similar structures and embodiments with the technical scheme of the invention, which are designed by the general skilled person in the art inspired by the invention, without creativity and without departing from the spirit of the invention, should be included in the protection scope of the invention.

1. A portable mobile phone fixed mount comprises a strap, a mobile phone clamp component and article placing bags;
said strap consists of a chest and waist belt and shoulder belts wherein on the chest and waist belt is provided with a hasp;
the mobile phone clamp component comprises a mounting plate, a mount adjusting mechanism and a mobile phone clamp; said mounting plate is arranged on the front side of the strap and is positioned at the joint of the chest and waist belt and the shoulder belts; the mount adjusting mechanism is rotatably connected with the mounting plate; the mount adjusting mechanism can be lifted and folded and is accommodated on the mounting plate; the mobile phone clamp is arranged on one side of mount adjusting mechanism away from the mounting plate;
a plurality of article placing bags are fixed on chest and waist belt.

2. The portable mobile phone fixed mount of claim 1 wherein the chest and waist belt comprises elastic bands and adjustable fixing bands, the chest and waist belt is connected with the shoulder belts through movable lantern rings, and can be adjusted and worn by people with different body types.

3. The portable mobile phone fixed mount of claim 1 wherein two parallel placing grooves are formed on the mounting plate along the longitudinal direction.

4. The portable mobile phone fixed mount of claim 3 wherein the mount adjusting mechanism comprises a rotating seat, a first rotating arm, a connecting shaft and a second rotating arm; the rotating seat is arranged between the two placing grooves; one end of the first rotating arm is rotatably connected with the rotating seat; the connecting shaft is rotatably arranged at one end of the first rotating arm far away from the rotating seat; the lower end of the second rotating arm is rotatably connected with the connecting shaft.

5. The portable mobile phone fixed mount of claim 4 wherein a sunshade connecting port is arranged at the top end of the second rotating arm.

6. The portable mobile phone fixed mount of claim 4 wherein groove body is equipped on the first rotating arm, and in the groove body is equipped with a rotatably connected auxiliary support bar, which is retractable, and support stability of first rotating arm can be strengthened when the bottom is pressed against the mounting plate.

7. The portable mobile phone fixed mount of claim 1 wherein there are three article placing bags, respectively positioned at the connecting parts of the spare chest and waist belt and the shoulder belts.

8. The portable mobile phone fixed mount of claim 1 wherein the strap is made of cow leather, artificial leather or elastic band.
